(19) United States
(12) Patent Application Publication
(10) Pub. No.: US 2022/0088612 A1
(43) Pub. Date: Mar. 24, 2022

(54) INTEGRATED DEEP PURIFICATION DEVICE FOR REMOVING SULFUR, NITRATE, DUST AND FLUORINE

(71) Applicant: Kunming University Of Science And Technolgy, Kunming City (CN)

(72) Inventors: Guangfei Qu, Kunming City (CN); Junyan Li, Kunming City (CN); Zhishuncheng Li, Kunming City (CN); Fenghui Wu, Kunming City (CN); Ping Ning, Kunming City (CN)

(21) Appl. No.: 17/465,121

(22) Filed: Sep. 2, 2021

(30) Foreign Application Priority Data
Sep. 19, 2020 (CN) 202010990886.4

(51) Int. Cl. B03C 3/017; B03C 3/155; B03C 3/49; B01D 53/14; B01D 53/18; B01D 53/32

(52) U.S. Cl. CPC B03C 3/017; B03C 3/155; B03C 3/49; B01D 2259/818; B01D 53/185; B01D 53/32; B01D 53/1481

(57) ABSTRACT

The invention discloses an integrated deep purification device for removing sulfur, nitrate, dust and fluorine. The core component of the device is a purification system; the purification system comprises a headstock, a container and a purification system which are connected with the back of the headstock, and the purification system is arranged in the container, and comprises a purification tower I and a purification tower II, wherein the purification tower I comprises a tower body I, corona electrodes I and conductive filters; the purification tower II comprises a tower body II, corona electrodes II, a sprinkler system and electrofiltration coupling units.

### FIELD OF THE INVENTION

The present invention belongs to the field of flue gas purification, and particularly relates to an integrated deep purification device for removing sulfur, nitrate, dust and fluorine that can be connected in parallel or series in a multistage way, and a using method thereof.

### BACKGROUND OF THE INVENTION

The nonferrous metals industry is the mineral processing industry, and one of main industries causing environmental pollution, with the characteristics of large logistics quantity and long technological process. Especially since the grade of metallic minerals in China is low, the structure is complex, and toxic metals and non-metallic elements often coexist, a large amount of harmful waste residues (rock), waste water and waste gas are generated in each process of mining, dressing, smelting and processing, thereby resulting in serious environment pollution. More than 300 million tons of greenhouse gas (converted in CO₂) may be discharged every year in production of the non-ferrous metals industry, and a large amount of other harmful gases, such as SO₂, NOx and SiF₄, are also discharged; and the sustainable development of China nonferrous metals industry is severely affected.

The development of synchronous desulfurization, denitrification and dust removal technologies is also a key problem that lots of nonferrous metals industries and mining and processing industries need to solve; and common flue gas dust removal includes cyclone dust removal, bag dust removal, membrane filtration, electric precipitation and electric-bag dust removal technologies. The dust removal efficiency of a traditional cyclone dust collector is only 20%-30%, and the removal effect of the particulate matter is not good. The operating temperature of a bag type dust collector is generally required to be lower than 280° C., and the treatment effect on fine dust is not ideal; the above traditional dust removal process not only is low in dust removal efficiency, but also high in operating environment requirements; the purpose of integrally and efficiently removing harmful constituents, such as sulfur, nitrate, dust and fluorine, cannot be achieved, and the current devices generally have the defects of large occupied area, limited application scenes, incapability of movable operation, etc., and cannot properly adapt to complex and variable working conditions; and the treatment cost of the flue gas is increased imperceptibly.

A traditional unit control technology is hard to meet the increasingly strict requirements for fine particulate matter purification, and people began to pay attention to the coupling effect of different technologies; the compound dust removal technology can make good use of the advantages of single dust removal technologies to achieve the highest removal efficiency. The patent Gas Purification Tower and Gas Purification Equipment (authorized publication patent No. CN208032296U) discloses gas purification equipment. The main innovation of the equipment lies in that a cutting device is arranged in a tank body; not only can fillers be fined through the device, but also the contact area between bubbles and liquor can be further increased; however, this purification method also adopts traditional chemical reaction absorption in essence, and the purification efficiency of fluorine, nitrate and other gases is not high; the purification method cannot adapt to various complex working conditions, or integrally and efficiently remove the harmful components, such as sulfur, nitrate, dust and fluorine. The patent Electrostatic Cyclone System Based on External Alternative Magnetic Enhancement (authorized publication patent No. CN203155405U) introduces a method that the direction of magnetic field force born by charged particulate matter in a dust collector is changed through external alternative magnetic control, and the action time of the charged particulate matter in an electric field is prolonged; finally, the charged particulate matter is removed through the electric field; although the removal efficiency of the particulate matter is improved through the method, the dust removal time is prolonged; the operating cost is increased, and the dust removal is liable to be affected with the particulate property and dust concentration; and consequently the efficient and stable dust removal efficiency cannot be kept.

### SUMMARY OF THE INVENTION

In order to solve the above problems, the present invention provides an integrated deep purification device for removing sulfur, nitrate, dust and fluorine, so that the purpose of purifying flue gas containing toxic and harmful substances, such as sulfur, nitrate, dust and fluorine, is achieved; the method is not only high in dust removal efficiency, but also flexible and changeable in treatment mode; different connection modes are adopted according to different flue gas properties, and the flue gas path is changed; and therefore, the series connection or parallel connection or entry order of the purification tower I and the purification tower II is achieved, and the purification efficiency is improved.

The vehicle-mounted mobile type of the integrated deep purification device for removing sulfur, nitrate, dust and fluorine comprises a headstock, a container connected at the back of the headstock, and a purification system arranged in the container; the field-fixed type comprises a purification system only. Wherein, the purification system comprises a purification tower I and a purification tower II, wherein the purification tower I comprises a tower body I, corona electrodes I and conductive filters; the purification tower II comprises a tower body II, corona electrodes II, a sprinkler system and electrofiltration coupling units; an air inlet I is formed in the upper part of the tower body I, and an air inlet pipe is connected with the air inlet I of the tower body I through a valve I; an air outlet I is formed in the lower part of the tower body I, and communicates with an air inlet II of the purification tower II through a valve V and a pipeline; the multiple conductive filters are arranged in the tower body I through brackets, and the corona electrodes I are arranged in the conductive filters; the corona electrodes I and the conductive filters are connected with negative and positive electrodes of a power supply separately, and an ash bucket is arranged at the bottom of the tower body I; the multiple electrofiltration coupling units are arranged in the tower body II through brackets, and more than two corona electrodes II are arranged around each electrofiltration coupling unit; the corona electrodes II and the electrofiltration coupling unit are connected with the negative and positive electrodes of the power supply separately; one path of an air outlet II of the tower body II is connected with an induced draft fan through a valve VI, and the other path of the air outlet II of the tower body II communicates with the air inlet I of the tower body I through a valve III; the air outlet I is connected with the induced draft fan through a valve II, and the air inlet pipe communicates with the air inlet II of the tower body II through the valve II and the pipeline; the sprinkler system is arranged on the inner top of the tower body II, and sprinklers of the sprinkler system are arranged in the electrofiltration coupling units; and the sprinkler system is connected with an absorption liquid storage tank through a pump, and a liquid outlet is formed in the bottom of the tower body II.

The conductive filters are hollow cylindrical cages with openings in the upper end or hollow cylinders with openings in the upper end and holes, which are formed by overlapping and welding longitudinal bars and support rings vertically and horizontally; the electrofiltration coupling units are hollow cylindrical cages with closed upper and lower ends or hollow cylinders with holes and closed upper and lower ends, which are formed by overlapping and welding longitudinal bars and support rings vertically and horizontally; preparation materials of the longitudinal bars, the support rings and the hollow cylinders are materials with resistance to temperature resistance and corrosion and high conductivity, specifically one of silicon carbide, carbon fibers, stainless steel, molybdenum, nickel-chromium alloy, Fe—Cr—Al alloy, zirconia and molybdenum disilicate; and the diameter of the holes in the conductive filters and the electrofiltration coupling units is 1˜100 μm.

The purification tower I further comprises filter cloth I, and the filter cloth I is arranged on the inner side walls of the conductive filters; and the purification tower II further comprises filter cloth II, and the filter cloth II is arranged on the outer side walls of the electrofiltration coupling units.

The filter cloth I and the filter cloth II are common filter cloth, electric filter cloth, metal filter cloth or filter cloth with catalysts loaded in the surface; the filter cloth is made of one of aluminum alloy, glass fiber, polytetrafluoroethylene, carbon fibers, silicon carbide, molybdenum, carbon fibers, stainless steel, nickel-chromium alloy, Fe—Cr—Al alloy, zirconia and molybdenum disilicide.

A preparation method for the filter cloth refers to: the method in authorized publication patent No. CN104213303 B “Electric filter cloth and application thereof”; catalysts loaded on the filter cloth are conventional commercially available catalysts capable of catalytically degrading contaminants or catalysts prepared with a conventional method, and the catalysts can be one or several of Ag, Pt, Co, Mn, Fe, Cu, TiO₂—SiO₂, Fe₂O₃—TiO₂, Fe₃O₄—TiO₂, CeO₂—TiO₂, MnO₂—TiO₂, ZrO₂—TiO₂ and Ag₂O—ZrO₂ at any ratio.

If the filter cloth is a common filter cloth, the discharge mode is dielectric barrier discharge; and if the filter cloth is a conductive filter cloth, the discharge mode is corona discharge.

The corona electrodes I and the corona electrodes II are one needle electrodes, dual-zone cylindrical electrodes, central bony spur-shaped electrodes, linear electrodes, dual-zone half bony spur electrodes and tapered grid electrodes, and the electrodes are made of one of silicon carbide, carbon fibers, stainless steel and pure molybdenum.

The flow rate of the air inlet and flue gas inlet of the purification tower I is 5 m/s˜23 m/s, and the gas temperature of the flue gas inlet is 50° C.˜600° C.; if the power supply is a DC high-voltage power supply, the discharge voltage is 10 kV˜100 kV; if the power supply is an AC high-voltage power supply, the AC discharge voltage is 10 kV˜300 kV; and if the power supply is a pulsed high-voltage power supply, the discharge voltage is 10 kV˜200 kV.

The flow rate of the air inlet and flue gas inlet of the purification tower II is 5 m/s˜23 m/s, and the gas temperature of the flue gas inlet is 50° C.˜600° C.; if the power supply is a DC high-voltage power supply, the discharge voltage is 10 kV˜80 kV; if the power supply is an AC high-voltage power supply, the AC discharge voltage is 10 kV˜200 kV; if the power supply is a pulsed high-voltage power supply, the discharge voltage is 10 kV˜100 kV; the corona electrodes in the tower can be replaced or selectively closed, and the purification tower II is used as a common absorption tower when the corona electrodes are closed.

The valves are replaced with flanges or blank flanges.

The sprinkler system is connected with an absorption liquid storage device through a pump, and absorption liquid can be conventional absorption liquid capable of adsorbing harmful substances in the gas, or absorption liquid prepared with the conventional method, which can be selected according to the requirements; for example, the absorption liquid can one or more of ammonia solutions with the mass concentration of 10%˜20%, cobalt metal ion complexing agents, ferric metal ion complexing agents, NaClO₂, KMnO₄, H₂O₂ oxidizing agents, microemulsion absorbents, ethylenediamine cobalt solutions; the spraying strength is 15˜20 m³/m²·h, and the sprinkles in the absorption tower can be replaced or closed selectively.

The using method of the above device is shown as follows:

Specific to different types of gas to be treated, a flow path of the gas to be treated in the device is changed through regulation of the opening and closing of a valve on a pipeline or change of a flange type, and therefore series connection or parallel connection or entry order of the purification tower I and the purification tower II is achieved; particulate matter is removed through the purification tower I in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

The device has the advantages:

(1) Not only is the device high in dust removal efficiency in the process of purifying industrial waste gas containing the sulfur, nitrate, dust and fluorine, but also the removal mode can be flexibly selected according to the characteristics of the flue gas; and the multi-stage series connection can be further achieved to improve the purification efficiency;

(2) The effects of a flow field and the electric field are applied to the purification process of the particulate matter simultaneously, and a coagulation and sedimentation removal mechanism of the fine particulate matter is studied to provide a technical option for economically and efficiently removing the fine particulate matter in the resource-based industry production;

(3) The device has a good treatment effect on dust-laden exhaust gas through the synergistic effect of various dust removal technologies, especially on effective capture of fine submicron particles with the particle size of 0.1˜2.5 μm;

(4) The device is high in movability, and can be transported by transportation means, such as trucks; the device can be transported in place if the device needs to be used, and is suitable for treating toxic gas leaking in emergency, as well as different complex working sites; the device can be transported in place according to the requirements of the working conditions.

### BRIEF DESCRIPTION OF THE FIGURES

FIG. 1 is a structure diagram of the device;

FIG. 2 is a top view structure diagram of the device;

In the figure: 1-purification tower I; 2-purification tower II; 3-corona electrode I; 4-conductive filter; 5-filter cloth I; 6-corona electrode II; 7-filter cloth II; 8-sprinkler system; 9-electrofiltration coupling units; 10-valve I; 11-valve II; 13-valve IV; 14-valve V; 15-valve VI; 16-pump; 17-induced draft fan; 18-air inlet I; 19-air outlet I; 20-air inlet II; 21-air outlet II; 22-liquid outlet; 23-ash bucket.

### DESCRIPTION OF THE INVENTION

A detailed description of the device is given below in combination with the drawings and embodiments, but the protection scope of the invention is not limited to the content.

The dust concentration in yellow phosphorus steam generated in the yellow phosphorus industry in China is higher, and generally 35-55 mg/m³, even higher than 100mg/m³ under the extreme conditions. In the production of the yellow phosphorus steam, the dust removal in yellow phosphorus production can include wet-method dust removal and a dray-method dust removal; most domestic yellow phosphorus production lines adopt a wet-method dust removal technology, but the wet-method dust removal not only consumes water, but also generates lots of phosphorus sludge; by taking advantaging of the integrated deep purification device for removing the sulfur, nitrate, dust and fluorine, flue gas is firstly dedusted through the purification tower through control over the valve or flange type; then, tail gas is purified through the purification tower, and phosphorus is collected; not only is the dust removal efficiency high in the process of purifying the yellow phosphorus steam, but also the dry-method dust removal does not consume water; and no phosphorus sludge is generated, and the disadvantages of the wet dust removal are overcome.

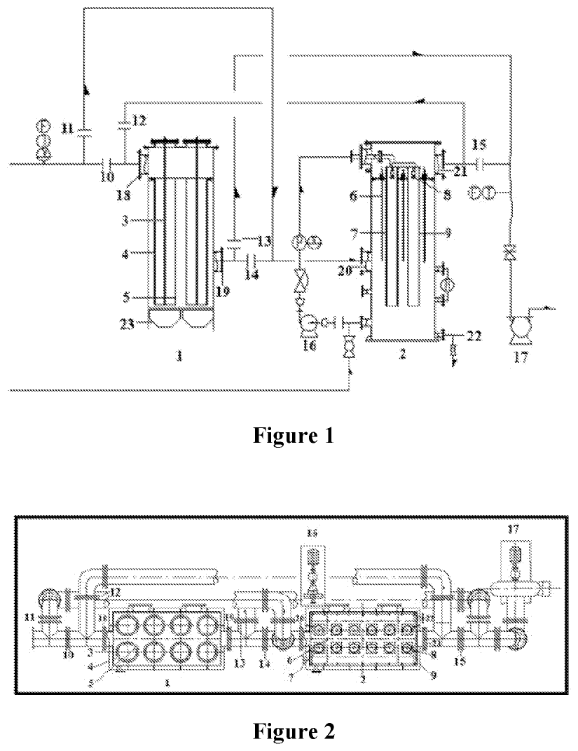

In Embodiment 1: as shown in FIGS. 1 and 2, the embodiment is a vehicle-mounted mobile type. The device comprises a headstock, a container connected at the back of the headstock, and a purification system arranged in the container; the purification system comprises a purification tower I 1 and a purification tower II 2; the purification tower I 1 comprises a tower body I, corona electrodes I 3, conductive filters 4 and filter cloth I 5; the purification tower II 2 comprises a tower body II, corona electrodes II 6, filter cloth II 7, a sprinkler system 8 and electrofiltration coupling units 9; an air inlet I is formed in the upper part of the tower body I, and an air inlet pipe is connected with the air inlet I of the tower body I through a valve I 10; an air outlet I is formed in the lower part of the tower body I, and communicates with an air inlet II of the purification tower II 2 through a valve V 14 and a pipeline; the six conductive filters 4 are arranged in the tower body I through brackets, and the corona electrodes I 3 are arranged in the conductive filters 4; the corona electrodes I 3 and the conductive filters 4 are connected with negative and positive electrodes of a power supply separately, and the filter cloth I 5 is arranged on the inner side walls of the conductive filters 4; an ash bucket 23 is arranged at the bottom of the tower body I; the 12 electrofiltration coupling units are arranged in the tower body II through brackets, and two corona electrodes II 6 are arranged around each electrofiltration coupling unit 9; the corona electrodes II 6 and the electrofiltration coupling units 9 are connected with the negative and positive electrodes of the power supply separately; one path of an air outlet II of the tower body II is connected with an induced draft fan 17 through a valve VI 13, and the other path of the air outlet II of the tower body II communicates with the air inlet I of the tower body I through a valve VI 15; the air outlet I is connected with the induced draft fan through a valve IV 13, and the air inlet pipe communicates with the air inlet II of the tower body II through the valve II 11 and the pipeline; the sprinkler system 8 is arranged on the inner top of the tower body II, and sprinklers of the sprinkler system 8 are arranged in the electrofiltration coupling units 9; and the sprinkler system 8 is connected with an absorption liquid storage tank through a pump 16, and a liquid outlet 22 is formed in the bottom of the tower body II;

In actual operation, the valve II 11 and the valve III 12 are closed, and the valve I 10 is opened; the valve IV 13 is closed, and the valve V 14 is opened; the valve VI 15 is opened; in this way, the series operation of the purification tower I 1 and the purification tower II 2 is achieved, and the gas firstly passes through the purification tower I 1, and then passes through the purification tower II 2.

200° C. high dust yellow phosphorus steam is introduced into the purification tower I 1 through the valve I 10, wherein the flue gas velocity is 10 m/s, the particulate matter concentration is 45 mg/m³, and the oxygen content is lower than 3%; the corona electrodes I 3 in the charging region are central bony spur-shaped electrodes, and are made of stainless steel; the positive electrodes are conductive filters 4, and the positive electrodes are made of silicon carbide materials, and welded into a hollow cylindrical cage with an opening in the upper end by overlapping longitudinal bars and support rings vertically and horizontally; the diameter of the holes in the positive electrodes is 50 μm; a layer of filter cloth I 5 made of glass fibers is adhered to the inner side wall of the cage, and the pore diameter of the filter cloth is 30 μm; the negative electrode and the positive electrode are connected with a 50 kV high-voltage DC power supply; the gas enters the charging region from the air inlet I 18 of the tower body I, and the particulate matter is charged at the charging region; the charged particulate matter is moved towards the conductive filters 4 of the dust collecting positive electrodes under the action of the electric field force, and a part of particulate matter falls in the ash bucket 23 after being intercepted by the filter cloth I, and the other part of particulate matter falls into the ash bucket 23 during cleaning with N₂; the treated tail gas is discharged from the air outlet I 19, and enters the purification tower II 2 through the valve V 14; in order to prevent the phosphorus from being oxidized by the free radicals, ozone and strong oxidizing substances generated in the power-on process, the corona electrodes II 6 and the electrofiltration coupling units in the purification tower II 2 in this embodiment are not powered on, and the purification tower II 2 only plays a role as the absorption tower; the flue gas dedusted through the purification tower I enters the tower body II from the valve V 14 through the air inlet II 20, wherein the absorption liquid falls into the bottom of the tower body II after being captured, and is discharged from the liquid outlet 22, and the tail gas is discharged from the air outlet II 21.

In Embodiment 2: the structure of the device used in this embodiment is a fixed type, different from that in Embodiment 1; the difference lies in that the purification tower I 1 excludes the filter cloth I 5; and there are no headstock or container connected at the back of the headstock.;

In actual operation, the valve I 10 is closed, and the valve II 11 is opened; the valve V 14 is closed, and the valve III 12 and the valve IV 13 are opened; the valve VI 15 is closed; in this way, the series operation of the purification tower II 2 and the purification tower I 1 is achieved, and the gas firstly passes through the purification tower II 2, and then passes through the purification tower I 1;

200° C. silicon smelting flue gas is introduced into the purification tower II 2 through the valve II 11, wherein the SO₂ concentration in the flue gas is 1,000 mg/m³, the NOx concentration is 750 mg/m³, and the particulate matter concentration is 2,000 mg/cm³; the flue gas first enters the charging region, and the cathode corona electrodes II 6 in the charging region are the needle electrodes; the anode electrofiltration coupling units 9 are hollow cylindrical cages with the closed upper and lower ends, which are formed by overlapping and welding longitudinal bars and support rings vertically and horizontally, and the diameter of the holes is 10 μm; the lower ends of the electrofiltration coupling units 9 penetrate into the absorption liquid for about 30 cm, and the cathode corona electrodes II and the anode electrofiltration coupling units 9 are connected with a 80 kV DC high-voltage power supply; the particulate matter is charged under the action of corona discharge; the gas enters the charging region from the air inlet II, and the charging region has a certain humidity under the spraying of the absorption liquid sprinkler system 8; the corona discharge phenomenon is generated under the DC high-voltage power supply, and the strong oxidizing substances, such as free radicals and ozone, are generated in a high-humidity space while the particulate matter is charged; wherein, the absorption liquid is 10% dilute ammonia water, and sulfur dioxide in the flue gas is transferred to liquid phases from gas phases; meanwhile, NOx is oxidized into NO₂ under the action of the strong oxidizing substances, such as free radicals and ozone, and absorbed by the absorption liquid; a part of charged particulate matter falls into the bottom of the tower body II after being captured by the absorption liquid, and another part of the charged particulate matter is moved towards the anode electrofiltration coupling units 9 under the action of the electric field force, and falls onto the bottom of the tower body II after being intercepted by the filter cloth II; the third part of the charged particulate matter is adhered to the surfaces of the electrofiltration coupling units, and rotary sprinklers are arranged in the electrofiltration coupling units, and used for spraying the surfaces of the electrofiltration coupling units under the water spraying pressure of 50 kg/cm² from inside to outside; the particulate matter adhered to the surfaces of the electrofiltration coupling units are further removed while the absorption removal of the sulfur, nitrate and dust is further improved; and the removal efficiency of the device is ensured. The purified gas enters the purification tower I through the valve III 12, and the gas passes through the charging region firstly; the corona electrodes I 3 in the charging region are tapered grid electrodes, and are made of silicon carbide; the positive electrodes are the conductive filters 4, and the positive electrodes are made of stainless steel materials, and welded into a hollow cylindrical cage with an opening in the upper end by overlapping longitudinal bars and support rings vertically and horizontally; the diameter of the holes in the positive electrodes is 80 μm; a layer of filter cloth I 5 made of glass fibers is adhered to the inner side wall of the cage, and the pore diameter of the filter cloth is 20 μm; the negative electrode and the positive electrode are connected with a 60 kV high-voltage DC power supply; the gas enters the charging region from the air inlet I, and wet mist is charged at the charging region; the charged acid mist is moved towards the conductive filters 4 of the dust collecting positive electrodes under the action of the electric field force, and therefore the purpose of electrically removing mist is achieved; and the gas after mist removal is discharged from the valve IV 13 and the induced draft fan 17.

The non-ferrous smelting flue gas emissions in China reach 3.62 trillion m³/a according to the Development Plan for Nonferrous Metals Industry (2016-2020), and the dust (smoke) emissions reach 384,801 t/a. The air environmental pollution problem caused by nonferrous smelting flue gas has become one of key factors restricting the sustainable development of the nonferrous metals industry. After dust removal with a wet-method dust removal process, the flue gas is used for acid making, or burnt to discharge, and the particulate emission concentration is up to 300 mg/m³. The wet-method process not only has the problem that a large amount of heavy metal particulate matter is discharged into atmosphere and consequently the heavy metal pollution and haze formation are accelerated, but also highly toxic refractory wastewater mixed with heavy metal, HCN, H₂S and the like can be further generated, and the wet-method process also results in great waste of the heavy metal and sulfur resources. If the wet method and the dry method are used in series, namely that the dry method is firstly adopted for efficiently removing dust and fine particulate matter from the tail gas, and then the wet method is used for absorbing made acid or treating the tail gas, it is expected to achieve all-component recovery of the tail gas, and the significant environmental benefits and economic benefits are created; and according to the method and device, the shortcomings of the wet method for dust removal are overcome.

In Embodiment 3: the structure of the device used in this embodiment is the same as that in Embodiment 1;

In actual operation, the valve II 11 and the valve III 12 are replaced with blind flanges, namely closed, and the valve I 10 is replaced with a flange, namely opened; the valve IV 13 is replaced with the blind flange, namely closed, and the valve V 14 is replaced with the flange, namely opened; the valve VI 15 is replaced with the flange, namely opened; in this way, the series operation of the purification tower I 1 and the purification tower II 2 is achieved, and the gas firstly passes through the purification tower I 1, and then passes through the purification tower II 2.

460° C. zinc smelting flue gas is introduced into the purification tower I 1 through the flange 10, wherein the velocity of the flue gas is 5 m/s, and the particulate matter concentration in the flue gas is 1,200 mg/cm3; SO2 concentration in the flue gas is 1,000 mg/m3; the corona electrodes I 3 in the charging region are the needle electrodes, and are made of molybdenum; the anode electrofiltration coupling units 4 are nickel-chrome alloy materials (hollow cylinders with openings in upper ends and holes, and the diameter of the holes is 20 μm; a layer of filter cloth I 5 (with catalysts loaded on the surface) is adhered to the exterior of the electrofiltration coupling units; the catalytic materials adhered to the surfaces of the electrofiltration coupling units are CeO2-TiO2 composite materials, and the hole diameter of the filter cloth is 50 μm; the negative electrodes and the positive electrodes are connected with the 80 kV DC high-voltage power supply; the gas enters the charging region from the air inlet I, and the particulate matter is charged in the charging region; a part of SO2 in the flue gas is oxidized into SO3 under the combined action of the corona discharge and catalytic filter cloth, and the charged particulate matter is moved towards the dust collecting anode electrofiltration coupling units under the action of the electric field force; a part of the charged particulate matter falls into the ash bucket after being intercepted by the filter cloth I; the other part of the charged particulate matter falls into the ash bucket during cleaning with N2 through a dust cleaning system; the treated tail gas is discharged from the air outlet I, and enters the purification tower II through the flange 14; the absorption liquid of the purification tower II is 10% dilute sulphuric acid; the flue gas firstly enters the charging area, and the cathode corona electrodes II in the charging region are the needle electrodes; the anode electrofiltration coupling units 9 are made of aluminum alloy materials, and are hollow cylindrical cages formed by overlapping and welding longitudinal bars and support rings vertically and horizontally, wherein the diameter of the holes is 10 μm; the lower ends of the electrofiltration coupling units 9 penetrate into the absorption liquid for about 30 cm, and the cathode corona electrodes II and the anode electrofiltration coupling units are connected with the 80 kV DC high-voltage power supply; the gas enters the charging region from the air inlet II, and the charging region has a certain humidity under the spraying of the absorption liquid sprinkler system 8; the corona discharge phenomenon is generated under the DC high-voltage power supply, and the strong oxidizing substances, such as free radicals and ozone, are generated in a high-humidity space; the SO2 in the flue gas is further oxidized into SO3, and under the spraying action of the absorption liquid, sulfur trioxide in the flue gas is transferred into liquid phases from gas phases to form finished sulfuric acid enriched at the bottom of the tower body II; the tail gas is discharged from the air outlet; at the moment, the dust concentration of the tail gas is 3 mg/m3, and the SO2 concentration is 10 mg/m3.

1. An integrated deep purification device for removing sulfur, nitrate, dust and fluorine,
characterized in that it comprises a vehicle-mounted mobile type and a field-fixed type, wherein the vehicle-mounted mobile type comprises a headstock, a container connected at the back of the headstock, and a purification system arranged in the container; the field-fixed type comprises a purification system only;
the purification system comprises a purification tower I (1) and a purification tower II (2), wherein the purification tower I (1) comprises a tower body I, corona electrodes I (3) and conductive filters (4); the purification tower II (2) comprises a tower body II, corona electrodes II (6), a sprinkler system (8) and electrofiltration coupling units (9); an air inlet I is formed in the upper part of the tower body I, and an air inlet pipe is connected with the air inlet I of the tower body I through a valve I (10); an air outlet I is formed in the lower part of the tower body I, and communicates with an air inlet II of the purification tower II (2) through a valve V (14) and a pipeline; the multiple conductive filters (4) are arranged in the tower body I through brackets, and the corona electrodes I (3) are arranged in the conductive filters (4); the corona electrodes I (3) and the conductive filters (4) are connected with negative and positive electrodes of a power supply separately, and an ash bucket is arranged at the bottom of the tower body I; the multiple electrofiltration coupling units (9) are arranged in the tower body II through brackets, and more than two corona electrodes II (6) are arranged around each electrofiltration coupling unit (9); the corona electrodes II (6) and the electrofiltration coupling unit (9) are connected with the negative and positive electrodes of the power supply separately; one path of an air outlet II of the tower body II is connected with an induced draft fan (17) through a valve VI (15), and the other path of the air outlet II of the tower body II communicates with the air inlet I of the tower body I through a valve III (12); the air outlet I is connected with the induced draft fan (17) through a valve IV (13), and the air inlet pipe communicates with the air inlet II of the tower body II through the valve II (11) and the pipeline; the sprinkler system (8) is arranged on the inner top of the tower body II, and sprinklers of the sprinkler system (8) are arranged in the electrofiltration coupling units (9); and the sprinkler system (8) is connected with an absorption liquid storage tank through a pump (16), and a liquid outlet (22) is formed in the bottom of the tower body II.

2. The integrated deep purification device for removing sulfur, nitrate, dust and fluorine, according to claim 1, characterized in that the conductive filters (4) are hollow cylindrical cages with openings in the upper end or hollow cylinders with openings in the upper end and holes, which are formed by overlapping and welding longitudinal bars and support rings vertically and horizontally; the electrofiltration coupling units (9) are hollow cylindrical cages with closed upper and lower ends or hollow cylinders with holes and closed upper and lower ends, which are formed by overlapping and welding longitudinal bars and support rings vertically and horizontally; preparation materials of the longitudinal bars, the support rings and the hollow cylinders are one of silicon carbide, carbon fibers, stainless steel, molybdenum, nickel-chromium alloy, Fe—Cr—Al alloy, zirconia and molybdenum disilicate; and the diameter of the holes in the conductive filters (4) and the electrofiltration coupling unit (9) is 1˜100 μm.

3. The integrated deep purification device for removing sulfur, nitrate, dust and fluorine, according to claim 2, characterized in that the purification tower I (1) further comprises filter cloth I (5), and the filter cloth I (5) is arranged on the inner side walls of the conductive filters (4); and the purification tower II (2) further comprises filter cloth II (7), and the filter cloth II (7) is arranged on the outer side walls of the electrofiltration coupling units (9).

4. The integrated deep purification device for removing sulfur, nitrate, dust and fluorine, according to claim 3, characterized in that the filter cloth I and the filter cloth II are common filter cloth, electric filter cloth, metal filter cloth or filter cloth with catalysts loaded in the surface; the filter cloth is made of one of aluminum alloy, glass fiber, polytetrafluoroethylene, carbon fibers, silicon carbide, molybdenum, carbon fibers, stainless steel, nickel-chromium alloy, Fe—Cr—Al alloy, zirconia and molybdenum disilicide.

5. The integrated deep purification device for removing sulfur, nitrate, dust and fluorine, according to claim 4, characterized in that the corona electrodes I (3) and the corona electrodes II (6) are one needle electrodes, dual-zone cylindrical electrodes, central bony spur-shaped electrodes, linear electrodes, dual-zone half bony spur electrodes and tapered grid electrodes, and the electrodes are made of one of silicon carbide, carbon fibers, stainless steel and pure molybdenum.

6. The integrated deep purification device for removing sulfur, nitrate, dust and fluorine, according to claim 1, characterized in that the flow rate of the air inlet and flue gas inlet of the purification tower I (1) is 5 m/s˜23 m/s, and the gas temperature of the flue gas inlet is 50° C.˜600° C.; if the power supply is a DC high-voltage power supply, the discharge voltage is 10 kV˜100 kV; if the power supply is an AC high-voltage power supply, the AC discharge voltage is 10 kV˜300 kV; and if the power supply is a pulsed high-voltage power supply, the discharge voltage is 10 kV˜200 kV.

7. The integrated deep purification device for removing sulfur, nitrate, dust and fluorine, according to claim 1, characterized in that the flow rate of the air inlet and flue gas inlet of the purification tower II (2) is 5 m/s˜23 m/s, and the gas temperature of the flue gas inlet is 50° C.˜600° C.; if the power supply is a DC high-voltage power supply, the discharge voltage is 10 kV˜80 kV; if the power supply is an AC high-voltage power supply, the AC discharge voltage is 10 kV˜200 kV; and if the power supply is a pulsed high-voltage power supply, the discharge voltage is 10 kV˜100 kV.

8. The integrated deep purification device for removing sulfur, nitrate, dust and fluorine, according to claim 1, characterized in that the valves are replaced with flanges or blank flanges.

9. A using method of the integrated deep purification device for removing sulfur, nitrate, dust and fluorine, according to claim 1, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

10. A using method of the integrated deep purification device for removing sulfur, nitrate, dust and fluorine, according to claim 2, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

11. A using method of the integrated deep purification device for removing sulfur, nitrate, dust and fluorine, according to claim 3, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

12. A using method of the integrated deep purification device for removing sulfur, nitrate, dust and fluorine, according to claim 4, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

13. A using method of the integrated deep purification device for removing sulfur, nitrate, dust and fluorine, according to claim 5, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

14. A using method of the integrated deep purification device for removing sulfur, nitrate, dust and fluorine, according to claim 6, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

15. A using method of the integrated deep purification device for removing nitrate, dust and fluorine, according to claim 7, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.

16. A using method of the integrated deep purification device for removing sulfur, nitrate, dust and fluorine, according to claim 8, characterized in that specific to different types of gas to be treated, a flow path of the gas to be treated in the device is changed through regulation of the opening and closing of a valve on a pipeline or change of a flange type, and therefore series connection or parallel connection or entry order of the purification tower I (1) and the purification tower II (2) is achieved; particulate matter is removed through the purification tower I (1) in the form of electrostatic precipitation or the filter cloth coupled with electrostatic precipitation, and under the airtight condition, the gas to be treated is introduced into a charging region from the top end of the tower body I; the corona electrodes are used as negative electrodes in the charging region, and the conductive filters are used as positive electrodes, as well as dust collecting electrodes; under the action of DC, AC or pulse high voltage, the particulate matter in the flue gas is charged at the charging region, and the particulate matter is effectively removed under the action of electric field force and micropore physical resistance through the charged particulate matter; the sulfur, nitrate, dust and fluorine are removed through the purification tower II (2) in the form of spray-coupled corona discharge or the filter cloth spray-coupled corona discharge, and under the airtight condition, the gas to be treated is introduced into the charging region from the bottom end of the tower body II; under the action of DC, AC or pulse high voltage, the charging region generates corona discharge and dielectric discharge to charge the particulate matter in the flue gas at the charging region and generate strong oxidizing substances; meanwhile, the gas to be treated is sprayed through the sprinkler system, and a part of sulfur, nitrate, dust, fluorine and other harmful constituents in toxic gas are absorbed by absorption liquid, and the rest sulfur, nitrate and fluorine are oxidized and removed through free radicals, ozone, plasma strong-oxidizing substances generated by discharging of the corona electrode II.
